(19) United States
(12) Patent Application Publication
(10) Pub. No.: US 2025/0230030 A1
(43) Pub. Date: Jul. 17, 2025

(54) UNLOADING HIGH VISCOUS FLUID PRODUCT FROM BAG CONTAINERS

(71) Applicant: JBT Marel Corporation, Chicago, IL (US)

(72) Inventors: Cody J. Lafountain, Fairfield, OH (US); Magnus Malmberg, Mjölby (SE); Jan Viberg, Mason, OH (US); Brandon R. Coles, Tampa, FL (US); Limin Zhang, Mason, OH (US)

(73) Assignee: JBT Marel Corporation, Chicago, IL (US)

(21) Appl. No.: 18/875,394

(22) PCT Filed: Jul. 11, 2023
(86) PCT No.: PCT/US2023/069949

§ 371 Date: Dec. 16, 2024

Related U.S. Application Data
(60) Provisional application No. 63/370,519, filed on Aug. 5, 2022.
(60) Provisional application No. 63/368,558, filed on Jul. 15, 2022.

(51) Int. Cl. B67D 7/02

(52) U.S. Cl. CPC B67D 7/0216; B67D 2210/0016

(57) ABSTRACT

A system for high pressure processing of bulk, high viscosity flowable product includes a carrier having openings therein for receiving high pressure fluid into the carrier. A flexible product bag is disposed in the product carrier, the bag having a fitment for filling and emptying the bag with high viscosity, flowable product. An opening in the product carrier for access to the fitment. An emptying system cooperates with the carrier to act on the filled product bag to increase the pressure on the product in the product bag to assist in forcing the high viscosity product out of the product bag. A control system controls the operation of the emptying system.

### CROSS-REFERENCES TO RELATED APPLICATIONS

This application claims the benefit of U.S. Provisional 63/368,558, filed Jul. 15, 2022, and the benefit of U.S. Provisional 63/370,519, filed Aug. 5, 2022, the entire contents of both of which applications are incorporated herein by reference.

### BACKGROUND

High pressure processing (HPP) is a batch processing method by which food products are subjected to very high pressure to inactivate food pathogens. Commercial HPP machines can achieve 5 log reductions in pathogens, similar to thermal pasteurization, but without the application of heat, thereby increasing the quality and taste of the food. However, there are some limitations. The food to be processed must be in the final retail package, typically an enclosed flexible bottle or film container. Hard packaging like glass bottles cannot be used. This requires that final food packages must be inserted into the HPP machine at low packing density, reducing the throughput of the machine and increasing processing costs.

HPP machines (presses) typically operate on batch cycles of typically 1 minute to 5 minutes each, but shorter and longer cycles may exist depending on the product to be processed. Plastic carriers or baskets are loaded with food products already packaged into final retail form. The pack density of liquid bottles and similar liquid containers for these carriers can be typically no higher than about 45%, meaning that only 45% of the volume of the carrier is filled with product.

Applicant has developed a bulk HPP processing system wherein a flexible bag that occupies substantially the entire volume of the carrier is filled with flowable product to be processed at a fill station away from the HPP pressure vessel or machine where the flowable product is pumped into the bag. The flowable product is subsequently pumped out from the bag at an unfill station, also located away from the HPP pressure vessel. After processing, the bag is connected to a pump at the unfill station for transferring the flowable product for packaging. The use of this bulk HPP processing system has substantially increased the volume of product that can be processed during each cycle of HPP processing. This bulk processing system is the subject matter of US Patent Publication 2021/050032 and of PCT publication WO 2022/060663 A1, both incorporated by reference in their entirety herein.

The current bulk HPP processing system is limited to use with low viscosity products that readily flow out of the flexible bag, especially when the bag opening is tilted downwardly. However, there are numerous high viscosity products, such as dips, salsas, hummus, etc., that would not readily flow out of flexible HPP bag. It is not feasible to use a suction pump in an attempt to extract the high viscosity products from the HPP bag. The negative pressure that can be drawn by such pumps is limited to 14.7 psi (1 atmosphere) This level of suction is insufficient to overcome the low-shear viscous forces of high viscosity fluid products, for example, products having a viscosity of greater than about 500 centiPoise (cP).

The present disclosure seeks to address HPP bulk processing of high viscosity (greater than about 500 cP) products, including food products.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure an apparatus is provided for use in the high pressure processing of bulk, high viscosity product. The apparatus includes a carrier having openings therein for receiving high pressure fluid into the carrier, a flexible product bag disposed in the carrier, the bag having a fitment for filling and emptying the bag with high viscosity, flowable product, an opening in the carrier for access to the fitment, and an emptying system cooperating with the carrier to press against the product bag while within the carrier to increase the pressure imposed on the high viscosity product in the product bag to assist in forcing the high viscosity product out of the product bag.

In any of the embodiments described herein, wherein the emptying system is selected from the group consisting of: a plunger and an actuator operating on the plunger to force the plunger against the product bag at a location spaced from the fitment to help force the high viscosity product out of the product bag through the fitment; at least one expandable bladder disposed within the carrier and a system for expanding the bladder, whereupon the bladder acts against the product bag to help force the high viscosity product out of the project bag through the fitment; an enclosure for receiving the carrier with the product bag disposed in the carrier, the enclosure having an opening for access to the fitment and an inlet in the enclosure at a location distal from the fitment to receive a fluid into the enclosure to act against the exterior of the product bag to reduce the volume of the product bag to help force the high viscosity product out of the product bag through the fitment; and at least one tension sheet within the carrier and surrounding the product bag and an actuator to pull on the tension sheet, thereby to squeeze the product bag to help force the high viscosity product out of the product bag through the fitment.

In any of the embodiments described herein, wherein the product bag is elongate with opposite end portions, the fitment is located at one of the end portions of the product bag, the plunger comprising a piston plate acting on the end portion of the product bag opposite to the location of the fitment, and an actuating rod projecting from the side of the piston plate opposite the product bag, to assist in forcing the high viscosity product out of the product bag.

In any of the embodiments described herein, wherein the product bag is elongate with opposite end portions, the fitment is located at one of the end portions of the product bag, and the at least one expandable bladder is selected from the group consisting of: a second bag that surrounds the product bag, a second bag that is disposed against one end portion of the product bag opposite to the location of the fitment, a second bag that is disposed against one end portion of the product bag opposite to the location of the fitment as well as disposed long the along the length of the product bag, a second bag that is disposed along at least the length of the product bag, and at least two second bags that are disposed along at least the length of the product bag at least at two separate locations along the length of the product bag, to assist in forcing the high viscosity product out of the product bag.

In any of the embodiments described herein, wherein the product bag is elongate with opposite end portions, the fitment is located at one of the end portions of the product bag, and the opening in the enclosure is located adjacent the end of the product bag opposite to the location of the fitment, to assist in forcing the high viscosity product out of the product bag.

In any of the embodiments described herein, wherein the product bag is elongate with opposite end portions, the fitment is located at one of the end portions of the product bag, the tension sheet is circumferentially wrapped around the product bag and extends outwardly through an elongate slot in the carrier; and the actuator draws the tension sheet out through the elongate slot to squeeze the product bag, thereby to squeeze the product bag to help force the high viscosity product out of the product bag through the fitment.

In any of the embodiments described herein, wherein the product bag is elongate with opposite end portions, the fitment is located at one of the end portions of the product bag, a first tension sheet section circumferentially surrounds approximately ½ of the product bag; a second tension sheet section circumferentially surrounds approximately ½ of the opposite circumferential side of the project bag, elongate slots are formed in the product carrier at diametrically opposite locations along the product carrier through which ends of the first and second tension sheet sections extend outwardly of the product carrier, and the actuator pulls on the ends of the first and second tension sheet sections extending outwardly of the slots in the product carrier, thereby to squeeze the product bag to force the high viscosity product out of the product bag through the fitment.

In any of the embodiments described herein, wherein the fitment extends through an opening in the carrier.

In any of the embodiments described herein, wherein the fitment extends through an opening in an end of the carrier.

In any of the embodiments described herein, further comprising a support for supporting the carrier in tilted orientation during the filling and emptying of the product bag while disposed within the carrier, to assist in forcing the high viscosity product out of the product bag.

In any of the embodiments described herein, wherein the support is tiltable relative to the horizontal, to assist in forcing the high viscosity product out of the product bag.

In any of the embodiments described herein, further comprising a control system to control the tilt of the product bag, to assist in forcing the high viscosity product out of the product bag.

In accordance with another embodiment of the present disclosure, a system for use with the high pressure processing of bulk, high viscosity flowable product is provided. The system includes a carrier having openings therein for receiving high pressure fluid into the carrier, a flexible product bag disposed in the product carrier, the bag having a fitment for filling and emptying the bag with high viscosity, flowable product, an opening in the product carrier for access to the fitment, an emptying system cooperating with the carrier to press against the filled product bag while within the carrier to increase the pressure on the product in the product bag to assist in forcing the product out of the product bag, and a control system for controlling the operation of the emptying system.

In any of the embodiments described herein, wherein the fitment extends through an opening in the carrier.

In any of the embodiments described herein, wherein the fitment extends through an opening in an end of the carrier.

In any of the embodiments described herein further comprising a support for supporting the carrier in tilted orientation during the filling and emptying of the product bag while disposed within the carrier.

In any of the embodiments described herein, wherein the support is tiltable relative to the horizontal.

In any of the embodiments described herein, wherein the emptying system is selected from the group consisting of: a plunger and an actuator operating on the plunger to force the plunger against the product bag at a location spaced from the fitment to increase the pressure on the product in the product bag to help force the high viscosity product out of the product bag through the fitment; at least one expandable bladder disposed within the carrier and a system for expanding the bladder, whereupon the bladder acts against the product bag to increase the pressure on the product in the product bag to help force the high viscosity product out of the project bag through the fitment; an enclosure for receiving the carrier with the product bag disposed in the carrier, the enclosure having an opening for access to the fitment and an inlet in the enclosure at a location distal from the fitment opening to receive a fluid into the carrier to act against the exterior of the product bag to reduce the volume of the product bag to increase the pressure on the product in the product bag to help force the high viscosity product out of the product bag through the fitment; and at least one tension sheet within the carrier and surrounding the product bag and an actuator to pull on the tension sheet, thereby to impose a squeezing force on the product bag to increase the pressure on the product in the product bag to help force the high viscosity product out of the product bag through the fitment.

In any of the embodiments described herein, wherein the product bag is elongate with opposite end portions, the fitment is located at one of the end portions of the product bag, the plunger comprising a piston plate acting on the end portion of the product bag opposite to the location of the fitment, and an actuating rod projecting from the side of the piston plate opposite the product bag, the actuator operating on the actuating rod, to assist in forcing the high viscosity product out of the product bag.

In any of the embodiments described herein, wherein the product bag is elongate with opposite end portions, the fitment is located at one of the end portions of the product bag, and the at least one expandable bladder is selected from the group consisting of: a second bag that surrounds the product bag and a second bag that is disposed against one end portion of the product bag opposite to the location of the fitment, a second bag that is disposed against one end portion of the product bag opposite to the location of the fitment as well as disposed long the along the length of the product bag, a second bag that is disposed along at least the length of the product bag, and at least two second bags that are disposed along at least the length of the product bag at least at two separate locations along the length of the product bag, to assist in forcing the high viscosity product out of the product bag.

In any of the embodiments described herein, wherein the product bag is elongate with opposite end portions, the fitment is located at one of the end portions of the product bag, and the opening in the enclosure is located adjacent the end of the product bag opposite to the location of the fitment.

In any of the embodiments described herein, wherein the product bag is elongate with opposite end portions, the fitment is located at one of the end portions of the product bag, the tension sheet is circumferentially wrapped around the product bag and extends outwardly through an elongate slot in the carrier, and the actuator drawing the tension sheet out through the elongate slot to squeeze the product bag.

In any of the embodiments described herein, wherein the product bag is elongate with opposite end portions, the fitment is located at one of the end portions of the product bag, a first tension sheet section circumferentially surrounds approximately ½ of the product bag, a second tension sheet section circumferentially surrounds approximately ½ of the opposite circumferential side of the project bag, elongate slots are formed in the product carrier at diametrically opposite locations along the product carrier through which ends of the first and second tension sheet sections extend outwardly of the product carrier, and the actuator pulling on the ends of the first and second tension sheet sections extending outwardly of the slots in the product carrier, thereby to squeeze the product bag.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic cross-sectional elevation view of an embodiment of the present disclosure;

FIG. 2A is a schematic cross sectional elevation view of a further embodiment of the present disclosure;

FIG. 2B is a cross-sectional view of FIG. 2A;

FIG. 3A is a schematic cross-sectional elevation view of a further embodiment of the present disclosure;

FIG. 3B is a schematic cross-sectional elevation view of a further embodiment of the present disclosure;

FIG. 3C is a schematic cross-sectional elevation view of a further embodiment of the present disclosure;

FIG. 3D is a schematic cross-sectional elevation view of a further embodiment of the present disclosure;

FIG. 4 is a schematic cross-sectional elevation view of a further embodiment of the present disclosure;

FIG. 5A is a schematic cross-sectional elevation view of a further embodiment of the present disclosure;

FIG. 5B is a schematic cross-sectional view of FIG. 5A;

FIG. 6A is a schematic cross-sectional elevation view of a further embodiment of the present disclosure;

FIG. 6B is the schematic-cross sectional view of FIG. 6A; and

FIG. 7 shows a product carrier disposed on a tilt table.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description and in the accompanying drawings, corresponding systems, assemblies, apparatus, and units may be identified by the same part number, but with an alpha suffix. The descriptions of the parts/components of such systems assemblies, apparatus, and units that are the same or similar are not repeated so as to avoid redundancy in the present application.

The present application refers to “processing medium” used in the HPP system for applying high pressure to the product being processed. Such processing medium is also referred to in the application as processing fluid or processing water as well as referred to as pressurized/pressure medium, pressurized/pressure fluid or pressurized water. All of these terms are to be used interchangeably.

In addition, the present application refers to the pressure vessel of an HPP apparatus. Such pressure vessel is also referred to as wire wound vessel or, simply, vessel. These terms are to be considered as synonymous. Further, the present application refers to a “product” or “products” that are subjected to or treated by HPP using the containers of the present disclosure. In particular to products of relatively high viscosity, which are defined as having a viscosity of 500 cP or higher, or of about 500 cP or higher. Products that receive HPP treatment using the system/apparatus of the present disclosure can have viscosities much higher than 50 0cP. Such product(s) may include all manner of foods, such as dips, salsas, hummus, yogurts, spreads, syrups, chocolate syrup, molasses, honey, nut butters, etc., as well as non-food products, such as cosmetics, pharmaceuticals, and organic materials and substances, wherein the control of pathogens is desirable.

Also, the present application interchangeably refers to the emptying, unloading, and unfilling of product from a product bag. No difference in meaning is intended by the interchangeable use of these terms.

In the bulk HPP processing of a high viscosity fluid products, at a filling station separate from the location of the HPP pressure vessel, a fill head removes the cap from the spout or fitment from a flexible product bag that has been placed into an HPP basket or carrier, and then the product is pumped through the spout or fitment into the flexible product bag. The bag can be tilted so that the spout or fitment is raised upward from the horizonal, especially as the flexible product bag is close to being filled. The carrier is then transported to the HPP pressure vessel and then the product is HPP processed.

Thereafter, the carrier is transferred from the HPP apparatus to an unfill station which is separate from the HPP pressure vessel. At the unfill station, an automated head assembly removes the cap from the spout or fitment of the flexible product bag and then grasps and connects to the spout or fitment so the product can be unloaded. Also at the unfill station, the carrier can be rotated upward from the horizontal to allow the cap to be removed without the product spilling out of the product bag, then rotated downward below the horizontal to utilize gravity to help remove the processed fluid product from the product bag.

The unfill station includes various sensors to detect when a carrier is present, is in the correct position, and is fully engaged with the unfill station. Additional sensors at the unfill station detect the fill level of the product bag, measure the flow of product into or out of the product bag, and measure the tilt angle of the carrier.

The unfill station further includes a system to apply external forces to the flexible product bag to increase the pressure on the product in the bag to help extract the processed product out of the product bag through the fitment in an aseptic manner to reach a pump for sending the product for further processing.

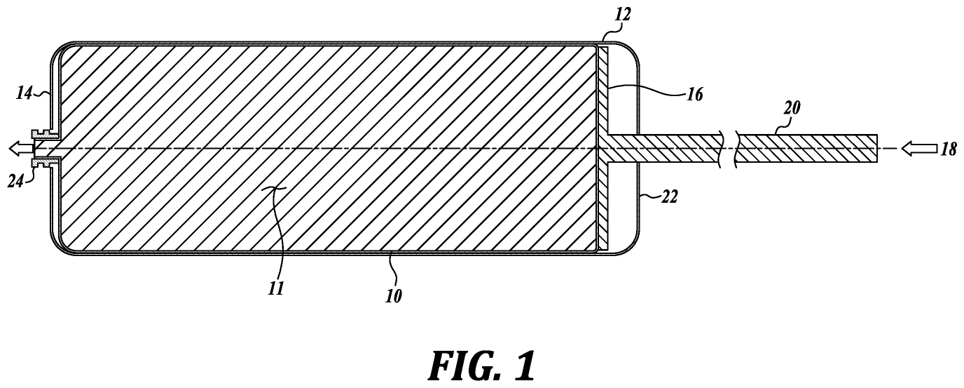

Various exemplary, but not exclusive, systems for applying external forces to the flexible product bag to help extract the processed product out of the product bag are provided by the present disclosure. Referring to the embodiment of the present disclosure shown in FIG. 1, a flexible product bag 10 containing high viscosity fluid product 11 is disposed in a carrier 12. At least one end 14 or other section of the carrier 12 is removable to enable the bag 10 to be placed into and removed from the carrier. Also, openings are located in carrier 12 to allow the pressure generated by the HPP apparatus to reach the bag 10.

To assist in forcing the high viscosity fluid product 11 out of the bag 10, a piston 16 is used to apply axial force to the product bag inside the carrier 12 in the direction of arrow 18. The piston closely fits within the carrier 12 and presents a flat surface against the adjacent end of the bag 10. A piston rod 20 extends through an opening in the carrier end wall 22 to move the piston 16 forwardly against the end of the product bag, seeking to collapse the bag. As a result, the piston applies a uniform axial pressure to the product bag 10 while the carrier 12 constrains the product bag in the other (radial) directions, thereby increasing the pressure everywhere in the product bag. The higher pressure at the spout or fitment 24 is enough to overcome the viscous forces in the product 11 and cause the product to flow out of the product bag through the spout to reach a pump.

The piston rod may be actuated using several methods, including electric, pneumatic, or hydraulic motors or actuators. Also, the piston rod can be detachable from the piston 16 so that the carrier can be placed into a HPP chamber or apparatus.

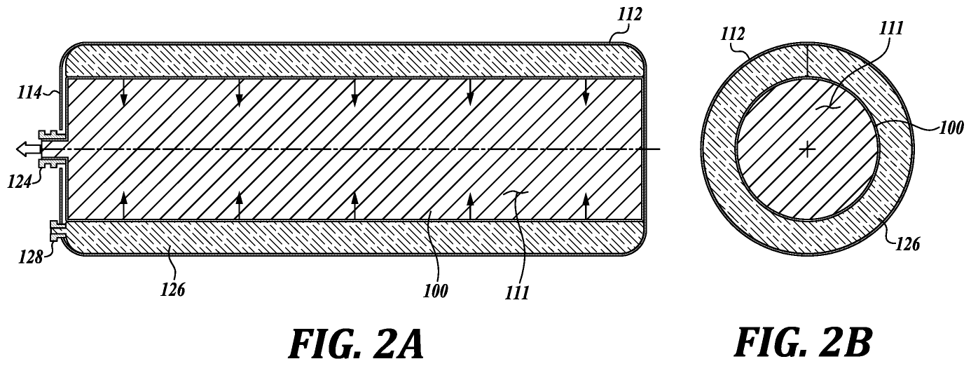

FIGS. 2A and 2B depict another embodiment of the present disclosure wherein a second flexible, expandable bag or bladder 126 is also contained inside the carrier 112 and circumferentially outward of the product bag 100. The second bag or bladder 126 can be toroidal in shape when inside the carrier 112, but may be either fully toroidal or unrolled into a rectangular shape when not contained inside the carrier. The second bag/bladder 126 is arranged around the inside wall of the carrier 112, and the product bag 100 is disposed within the second bag/bladder.

The second bag/bladder 126 has its own spout or fitment 128 through which a second fluid is pumped into the second bag/bladder, causing the second bag/bladder to expand inward radially because it is constrained from expanding outwardly by the carrier. As a result, a radial uniform pressure is applied to the product bag 100, increasing the pressure everywhere in the product bag, tending to collapse the product bag. The higher pressure at the spout or fitment 124 is enough to overcome the viscous forces in the product 111 and cause the product to flow out through the fitment 124 to reach a pump.

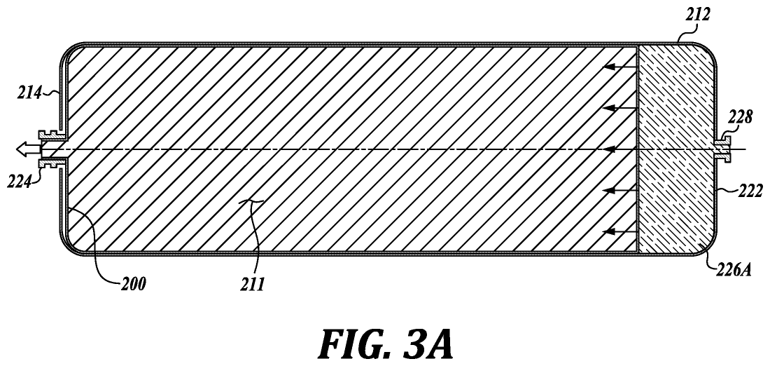

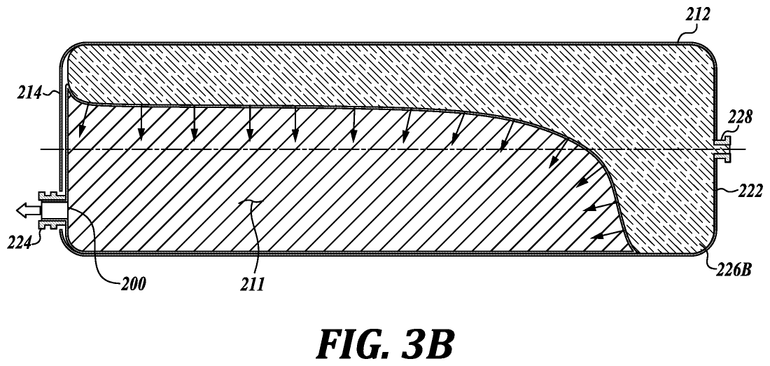

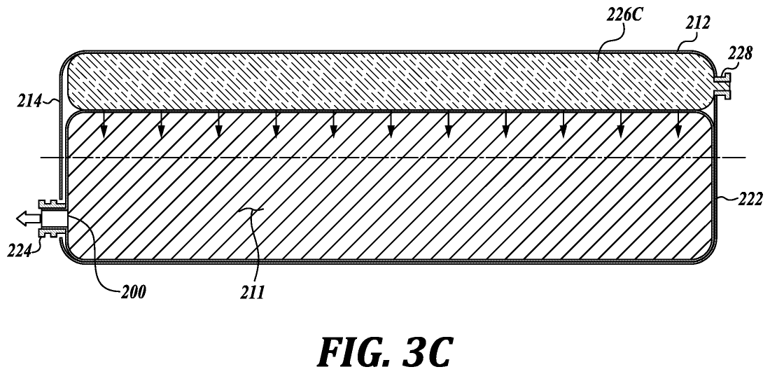

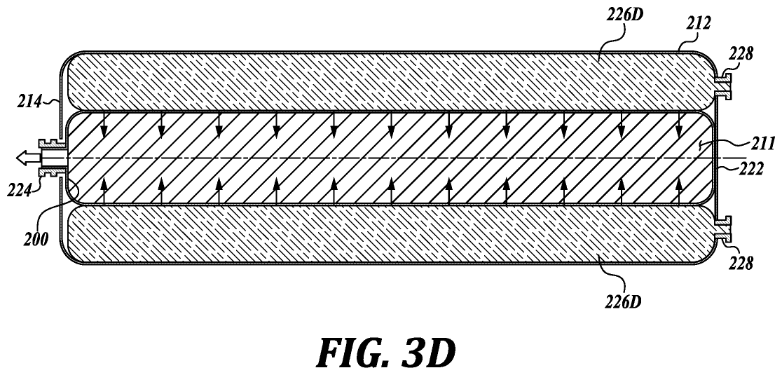

FIG. 3A depicts another embodiment of the present disclosure wherein a second flexible, expandable bag or bladder 226 is also contained inside the carrier 212. The second bag or bladder, when expanded, is cylindrical in shape, but when collapsed takes up minimal volume within the carrier 112, lying against the inside surface of carrier end 222.

The second bag/bladder has a fitment 228 through which a second fluid is pumped into the second bag/bladder. FIG. 3A shows the second bag/bladder 226 partially expanded. The second bag/bladder expands inward axially away from carrier end 222 because the second bag is constrained by the carrier. In this manner, the second bag/bladder applies a uniform axial pressure on the product bag 200, tending to collapse the product bag 200 and increasing the pressure everywhere in the product bag. The higher pressure of the product 211 at the fitment 224 is enough to overcome the viscous forces in the product and cause the product to flow out through the fitment 224 to reach a pump.

Alternatively, a single bag/bladder can by utilized that has two identical compartments, each compartment having its own fitment that protrudes the load basket/carrier. During loading, the product is filled in one compartment while the other would get drained. The product being loaded into the compartment will force the processed product out the other compartment.

FIG. 3B depicts a variation of the embodiment of FIG. 3A. In FIG. 3B, a second bag or bladder 226B is configured to expand from both the carrier end 222 as well as along the length of the carrier 212. In this manner, pressure is applied to the product 200 from both the carrier end 222 as well as long the entire length of the product bag. The fitment 224 is shown as located off-center relative to the bladder 226B; however, the fitment could be located “on-center” as shown in FIG. 3A, with the shape of the bladder 226B designed so as not to close off the fitment. In other respects, the embodiment of FIG. 3B is the same or similar to the embodiment of FIG. 3A.

FIG. 3C depicts a variation of the embodiments of FIGS. 3A and 3B. In FIG. 3C, a second bag or bladder 226C is configured to expand from along the length of the carrier 212. In this manner, pressure is applied to the product 211 along the entire length of the product bag 200. The fitment 224 is shown as located “off-center” relative to the bladder 226C. However, the fitment could be located “on-center” as shown in FIG. 3A, with the shape of the bladder 226C designed so as not to close off the fitment. In other respects, the embodiment of FIG. 3C is the same or similar to the embodiments of FIGS. 3A and 3B.

FIG. 3D depicts a variation of the embodiments of FIGS. 3A, 3B and 3C. In FIG. 3D, two bags or bladders 226D are configured to expand from along the length of the carrier 112. The bags or bladders can be positioned in diametrically opposite positions within the carrier 212. This configuration allows pressure to be applied to the product 211 along the entire length of the product bag 200 along two pressure fronts. In other respects, the embodiment of FIG. 3D is the same or similar to the embodiments of FIGS. 3A, 3B, and 3C.

It will be appreciated that the bags or bladders 226 can be of other configurations than shown in FIGS. 3A-3D. Further, that more than two bags or bladders can be used to remove the product 211 from the product bag 200. For example, in addition to the two bladders 226D shown in FIG. 3D, a third bladder could be located at the end 222 of the product carrier, such as shown in FIG. 3A.

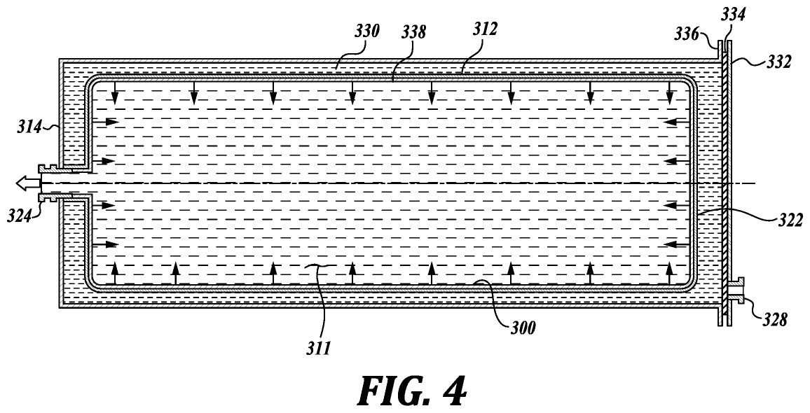

FIG. 4 depicts another embodiment of the present disclosure wherein the carrier 312 is placed within an enclosure 330 which is constructed in the form of a tank structure that may be exposed to internal pressure. In this regard, the enclosure 330 includes a removeable end cover or lid 332. A seal 334 is interposed between a flange 336 formed at the end of enclosure and the lid 332.

A second fluid 338, such as water or air, may be introduced into the enclosure under pressure using a pump. The carrier 312 has holes or perforations so the second fluid 338 can enter and surround the product bag 300. The second fluid 338 applies uniform pressure on all sides of the product bag 300, increasing the pressure everywhere in the product bag, tending to collapse the product bag 300. The higher pressure of the product 311 at the fitment 324 of the product bag 300 is enough to overcome the viscous forces in the product, causing the product to flow out through the fitment to a pump.

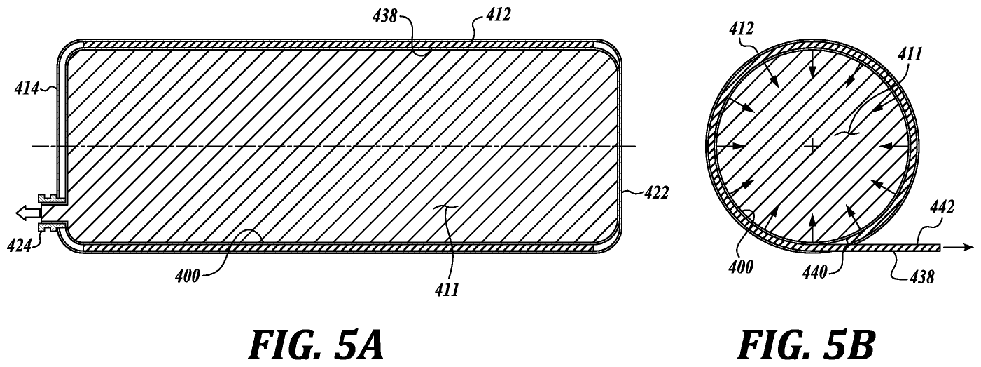

FIGS. 5A and 5B depict another embodiment of the present disclosure wherein a flexible and durable tension sheet 438 is wrapped in a spiral manner around the product bag 400 in one or more layers. The tension sheet 438 may be constructed from a strong, flexible material with a low friction coefficient, such as ultra-high-molecular-weight polyethylene (UHMW PE) or PTFE.

One end edge 440 of the tension sheet 438 is anchored to the interior of the carrier 412. The opposite end edge 442 of the tension sheet is pulled using a mechanized system to draw the tension sheet out through a slot formed along the length of the carrier 412, thereby to apply radial pressure to the circumference of the product bag 400, tending to collapse the product bag 400. This increases the pressure of the product 411 at the fitment 424 sufficient to overcome the viscous forces in the product and cause the product to flow out through the fitment to reach a pump.

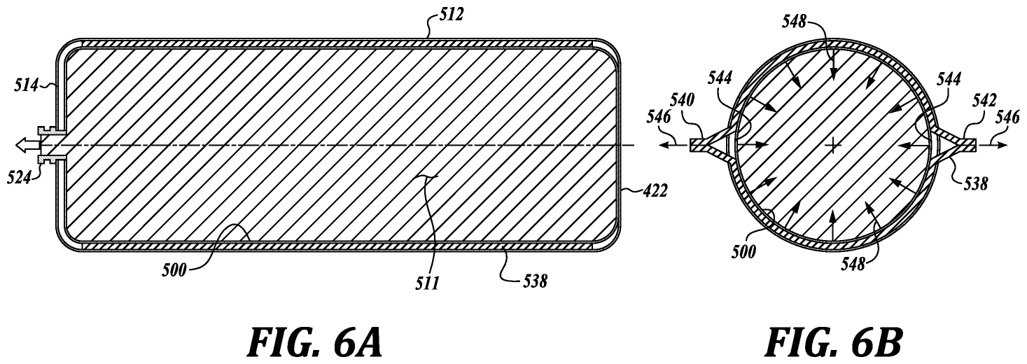

FIGS. 6A and 6B depict another embodiment of the present disclosure wherein a single flexible and durable tension sheet 538 or two joined flexible and durable tension sheets line the interior surface of the carrier 512 and surround the product bag 500. The tension sheet(s) 538 are made of a strong, flexible material with a low friction coefficient, such as ultra-high-molecular-weight polyethylene (UHMW PE) or PTFE.

The end portions 540 and 542 of tension sheet(s) 538 are mechanically pulled in two diametrically opposite directions separated by a mechanized system to be drawn out of the carrier 512 through slots 544 formed along the length of the carrier as depicted by arrows 546. As a result, the tension sheet(s) 538 squeeze the product bag by applying a radial inward pressure to the product bag, tending to collapse the product bag. This increases the pressure of the product 511 in the product bag 500 depicted by arrows 548 at the fitment 524 sufficient to overcome the viscous forces in the product and cause the product to flow out through the fitment to a pump.

It will be appreciated that the location(s) where the product bags 10, 100, 200, 300, 400, and 500 are filled and unfilled is/are not within the chamber or pressure vessel were the HPP occurs. The product bags are filled and unfilled at a common location (or at different locations) separate from the pressure vessel while within a carrier. As such, the filling and/or unfilling of the product bags does not occupy any processing time of the pressure vessel, nor does the filling and/unfilling station(s) occupy any pressure vessel space.

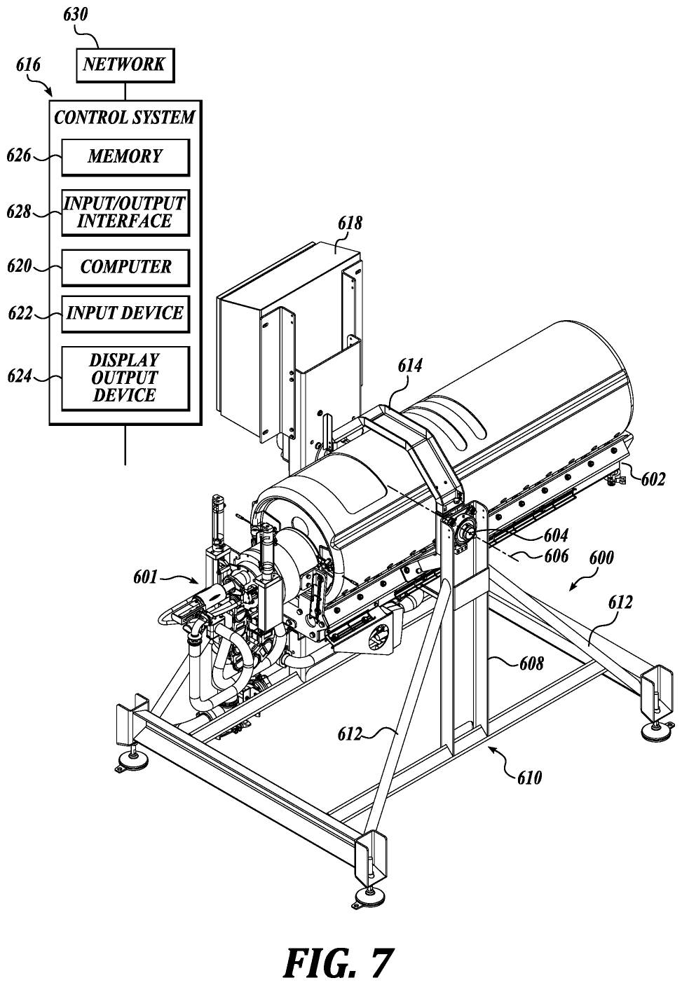

FIG. 7 illustrates a carrier, for example carrier 12, as mounted on a tilting table structure 600. A flow valve 601 is shown as connected to the fitment 24 (not visible) for emptying the product bag 10. The table structure 600 includes a longitudinal platform 602 on which the carrier 12 is supported. A series of rollers can be mounted along each side of the platform 602, as well as elsewhere along the platform for bearing against the exterior side portion of the carrier 12 for assisting in the loading and unloading the carrier from the table structure 600.

The platform 602 is pivotally mounted by bearings 604 about a transverse axis 606 to the upper ends of upright support posts 608 that extend upwardly from a base structure 610. Diagonal bars 612 extend from the corners of the base structure 610 to the upper ends of the support posts 608 for enhanced structural integrity of the table structure 600.

A strap like structure 614 extends around the carrier 12 to interconnect the upper ends of the posts 608 also for the structural integrity of the table structure 600.

A motor, not visible, is provided to change the orientation of the platform 602 about axis 606. A control system 616 is located in control housing 618, and functions to control the operation of the motor and thus the tilt of the table platform 602 about axis 606.

In this regard, the table structure 600 can be tilted so that the fitment is raised relative to the bag 10 when filling the bag. Also, the table structure 600 can be tilted so that the fitment is raised relative to the bag 10 to open the fitment and then lowered relative to the bag to empty the bag and the raised relative to the bag after emptying the bag to close the fitment. Of course, other sequences of the tilting of the table structure can be used when filling and/or un-filling the product bag 10.

The control system 616 is schematically shown in FIG. 7. In this regard, the control system includes a computer or processor 620, an input device 622 (keyboard, mouse, touchscreen, etc.), and an output device 624 (touchscreen, monitor, printer, etc.). The control system 616 also includes a memory unit 626. In addition, the control system includes an input/output interface 628 for receiving and sending signals and information from and to the HPP press, the flow control valve 601, and the tilting table 600, among other components.

The control system 616 may be connected to a network 630 rather than employing the local control system 616. A network computing/control system can be used for this purpose.

While illustrative embodiments have been illustrated and described, it will be appreciated that various changes can be made therein without departing from the spirit and scope of the invention. In this regard, the product bags 10, 100, 200, 300, 400 and 500 can be of various sizes and volumes. For example, the product bags can have a capacity as small as of about 20 to 25 liters, to a capacity of at least 200 to 250 liters or even larger. Of course, the product bags can be of an even smaller capacity as well as be of an even larger capacity.

Also, the tilting table 600 could be replaced with other structures to support and tilt a carrier, such as carrier 12, during filling and un-filling of the carrier 12.

1. An apparatus for use in the high pressure processing of bulk, high viscosity product, comprising:
a. a carrier having openings therein for receiving high pressure fluid into the carrier;
b. a flexible product bag disposed in the carrier, the bag having a fitment for filling and emptying the bag with high viscosity, flowable product;
c. an opening in the carrier for access to the fitment;
d. an emptying system cooperating with the carrier to press against the product bag while within the carrier to increase the pressure imposed on the high viscosity product in the product bag to assist in forcing the high viscosity product out of the product bag.

2. The apparatus of claim 1, wherein the emptying system is selected from the group consisting of:
a. a plunger and an actuator operating on the plunger to force the plunger against the product bag at a location spaced from the fitment to help force the high viscosity product out of the product bag through the fitment;
b. at least one expandable bladder disposed within the carrier and a system for expanding the bladder, whereupon the bladder acts against the product bag to help force the high viscosity product out of the project bag through the fitment;
c. an enclosure for receiving the carrier with the product bag disposed in the carrier, the enclosure having an opening for access to the fitment and an inlet in the enclosure at a location distal from the fitment to receive a fluid into the enclosure to act against the exterior of the product bag to reduce the volume of the product bag to help force the high viscosity product out of the product bag through the fitment;
d. at least one tension sheet within the carrier and surrounding the product bag and an actuator to pull on the tension sheet, thereby to squeeze the product bag to help force the high viscosity product out of the product bag through the fitment.

3. The apparatus of claim 2, wherein:
a. the product bag is elongate with opposite end portions;
b. the fitment is located at one of the end portions of the product bag;
c. the plunger comprising a piston plate acting on the end portion of the product bag opposite to the location of the fitment;
d. an actuating rod projecting from the side of the piston plate opposite the product bag.

4. The apparatus of claim 2, wherein:
a. the product bag is elongate with opposite end portions;
b. the fitment is located at one of the end portions of the product bag;
c. the at least one expandable bladder is selected from the group consisting of:
a second bag that surrounds the product bag, a second bag that is disposed against one end portion of the product bag opposite to the location of the fitment, a second bag that is disposed against one end portion of the product bag opposite to the location of the fitment as well as disposed long the along the length of the product bag, a second bag that is disposed along at least the length of the product bag, and at least two second bags that are disposed along at least the length of the product bag at least at two separate locations along the length of the product bag.

5. The apparatus of claim 2, wherein:
a. the product bag is elongate with opposite end portions;
b. the fitment is located at one of the end portions of the product bag;
c. the opening in the enclosure is located adjacent the end of the product bag opposite to the location of the fitment.

6. The apparatus of claim 2, wherein:
a. the product bag is elongate with opposite end portions;
b. the fitment is located at one of the end portions of the product bag;
c. the tension sheet is circumferentially wrapped around the product bag and extends outwardly through an elongate slot in the carrier; and
d. the actuator draws the tension sheet out through the elongate slot to squeeze the product bag, thereby to squeeze the product bag to help force the high viscosity product out of the product bag through the fitment.

7. The apparatus of claim 2, wherein:
a. the product bag is elongate with opposite end portions;
b. the fitment is located at one of the end portions of the product bag;
c. a first tension sheet section circumferentially surrounds approximately ½ of the product bag;
d. a second tension sheet section circumferentially surrounds approximately ½ of the opposite circumferential side of the project bag;
e. elongate slots are formed in the product carrier at diametrically opposite locations along the product carrier through which ends of the first and second tension sheet sections extend outwardly of the product carrier;
f. the actuator pulls on the ends of the first and second tension sheet sections extending outwardly of the slots in the product carrier, thereby to squeeze the product bag to force the high viscosity product out of the product bag through the fitment.

8. The apparatus of claim 1, wherein the fitment extends through an opening in the carrier.

9. (canceled)

10. The apparatus of claim 1, further comprising a support for supporting the carrier in tilted orientation during the filling and emptying of the product bag while disposed within the carrier.

11. (canceled)

12. The apparatus of claim 10, further comprising a control system to control the tilt of the product bag.

13. A system for use with the high pressure processing of bulk, high viscosity flowable product, comprising:
a. a carrier having openings therein for receiving high pressure fluid into the carrier;
b. a flexible product bag disposed in the product carrier, the bag having a fitment for filling and emptying the bag with high viscosity, flowable product;
c. an opening in the product carrier for access to the fitment;
d. an emptying system cooperating with the carrier to press against the filled product bag while within the carrier to increase the pressure on the product in the product bag to assist in forcing the product out of the product bag;
e. a control system for controlling the operation of the emptying system.

14. The system of claim 13, wherein the fitment extends through an opening in the carrier.

15. (canceled)

16. The system of claim 13, further comprising a support for supporting the carrier in tilted orientation during the filling and emptying of the product bag while disposed within the carrier.

17. The system of claim 16, wherein the support is tiltable relative to the horizontal.

18. The system of claim 13, wherein the emptying system is selected from the group consisting of:
a. a plunger and an actuator operating on the plunger to force the plunger against the product bag at a location spaced from the fitment to increase the pressure on the product in the product bag to help force the high viscosity product out of the product bag through the fitment;
b. at least one expandable bladder disposed within the carrier and a system for expanding the bladder, whereupon the bladder acts against the product bag to increase the pressure on the product in the product bag to help force the high viscosity product out of the project bag through the fitment;
c. an enclosure for receiving the carrier with the product bag disposed in the carrier, the enclosure having an opening for access to the fitment and an inlet in the enclosure at a location distal from the fitment opening to receive a fluid into the carrier to act against the exterior of the product bag to reduce the volume of the product bag to increase the pressure on the product in the product bag to help force the high viscosity product out of the product bag through the fitment;
d. at least one tension sheet within the carrier and surrounding the product bag and an actuator to pull on the tension sheet, thereby to impose a squeezing force on the product bag to increase the pressure on the product in the product bag to help force the high viscosity product out of the product bag through the fitment.

19. The system of claim 18, wherein:
a. the product bag is elongate with opposite end portions;
b. the fitment is located at one of the end portions of the product bag;
c. the plunger comprising a piston plate acting on the end portion of the product bag opposite to the location of the fitment;
d. an actuating rod projecting from the side of the piston plate opposite the product bag, the actuator operating on the actuating rod.

20. The system of claim 18, wherein:
e. the product bag is elongate with opposite end portions;
f. the fitment is located at one of the end portions of the product bag;
g. the at least one expandable bladder is selected from the group consisting of a second bag that surrounds the product bag and a second bag that is disposed against one end portion of the product bag opposite to the location of the fitment, a second bag that is disposed against one end portion of the product bag opposite to the location of the fitment as well as disposed long the along the length of the product bag, a second bag that is disposed along at least the length of the product bag, and at least two second bags that are disposed along at least the length of the product bag at least at two separate locations along the length of the product bag.

21. The system of claim 18, wherein:
a. the product bag is elongate with opposite end portions;
b. the fitment is located at one of the end portions of the product bag;
c. the opening in the enclosure is located adjacent the end of the product bag opposite to the location of the fitment.

22. The system of claim 18, wherein:
a. the product bag is elongate with opposite end portions;
b. the fitment is located at one of the end portions of the product bag;
c. the tension sheet is circumferentially wrapped around the product bag and extends outwardly through an elongate slot in the carrier; and
d. the actuator drawing the tension sheet out through the elongate slot to squeeze the product bag.

23. The system of claim 18, wherein:
a. the product bag is elongate with opposite end portions;
b. the fitment is located at one of the end portions of the product bag;
c. a first tension sheet section circumferentially surrounds approximately ½ of the product bag;
d. a second tension sheet section circumferentially surrounds approximately ½ of the opposite circumferential side of the project bag;
e. elongate slots are formed in the product carrier at diametrically opposite locations along the product carrier through which ends of the first and second tension sheet sections extend outwardly of the product carrier;
f. the actuator pulling on the ends of the first and second tension sheet sections extending outwardly of the slots in the product carrier, thereby to squeeze the product bag.
